(19) United States
(12) Patent Application Publication
(10) Pub. No.: US 2010/0270807 A1
(43) Pub. Date: Oct. 28, 2010

(54) METHODS AND APPARATUS FOR PRODUCING ENERGY FROM EXHAUST STREAMS

(76) Inventor: DAVID WYLIE MANNING, Bayshore, TX (US)

Correspondence Address: GILBRETH & ASSOCIATES, P.C., PO BOX 2428, BELLAIRE, TX, 77402-2428, US

(21) Appl. No.: 12/430,208

(22) Filed: Apr. 27, 2009

(51) Int. Cl. F03D 9/00

(52) U.S. Cl. 290/55

(57) ABSTRACT

Methods and apparatus for generating electricity in which exhaust from gas turbines or internal combustion engines are utilized to power wind machines and thus generate electricity.

### BACKGROUND OF THE INVENTION

1. Field of the Invention

The present invention relates to methods and apparatus for the generation of electricity. In another aspect, the present invention relates to methods and apparatus for the generation of electricity through the harnessing of gaseous fluids. In even another aspect, the present invention relates to methods and apparatus for the generation of electricity through the harnessing of exhaust gaseous fluids. In still another aspect, the present invention relates to methods and apparatus for the generation of electricity through the harnessing of gaseous fluids exiting gas turbines or reciprocating engines. In yet another aspect, the present invention relates to methods and apparatus for the generation of electricity through the harnessing of gaseous fluids exiting gas turbines or reciprocating engines, which are also producing electricity.

2. Brief Description of the Related Art

A wind turbine is a rotating machine that converts the kinetic energy in wind into mechanical energy. If the mechanical energy is used directly by machinery, such as a pump or grinding stones, the machine is usually called a windmill. However, if the mechanical energy is then converted to electricity, the machine is usually called a wind generator, wind turbine, wind power unit (WPU), wind energy converter (WEC), or aerogenerator. As used herein, the term “wind machine” will refer to a wind powered electricity generating apparatus, non-limiting examples of which include wind generator, wind turbine, wind power unit (WPU), wind energy converter (WEC), or aerogenerator.

In a broad sense, wind power is the conversion of wind energy into a useful form, such as electricity, using wind turbines. At the end of 2008, worldwide nameplate capacity of wind-powered generators was estimated on the order of 120 gigawatts. Although wind produces only about 1.5% of worldwide electricity use, it is growing rapidly due to green advocacy and spikes in prices of conventional power. In several countries it has achieved relatively high levels of penetration of electricity production, such as, for example, in Denmark, Spain, Portugal, Germany and the Republic of Ireland.

Wind energy has historically been used directly to propel sailing ships or converted into mechanical energy for pumping water or grinding grain, but the principal application of wind power today is the generation of electricity. Wind power, along with solar power, is non-dispatchable, meaning that for economic operation all of the available output must be taken when it is available, and other resources, such as hydroelectricity, must be used to match supply with demand.

Large scale wind farms are typically connected to the local electric power transmission network, with smaller turbines being used to provide electricity to isolated locations. Utility companies increasingly buy back surplus electricity produced by small domestic turbines. Wind energy is favored by many environmentalists as an alternative to fossil fuels, as it is plentiful, renewable, widely distributed, clean, and produces lower greenhouse gas emissions, although the construction of wind farms is not universally welcomed due to their visual impact and other effects on the environment.

The intermittency of wind seldom creates problems when using wind power to supply a low proportion of total demand. Unfortunately, if wind generated electricity is to play an important role, this problem of intermittency becomes more acute when attempting to use wind power to supply a relatively large portion of total demand.

Specifically, unlike fueled generating plants, the capacity factor is limited by the inherent properties of wind. Since wind speed is not constant, a wind farm's annual energy production is never as much as the sum of the generator nameplate ratings multiplied by the total hours in a year. The ratio of actual productivity in a year to this theoretical maximum is called the capacity factor. Typical capacity factors are 20-40%, with values at the upper end of the range in particularly favorable sites.

There are also geographic issues with wind power, as some locations are more desirable than others, when it comes to the availability of wind. The desirable wind locations may be distant from the demand, creating transmission issues.

It is also many times necessary to mount specially wind machines to take advantage of wind above the ground. For example, on towers or a building rooftop. The wind speed is slower at a lower altitude, so less wind energy is available for a given size turbine. Air flow near the ground and other objects may create turbulent flow, which can introduce issues of vibration, including noise and bearing wear which may increase the maintenance or shorten the service life. However, when a turbine is mounted on a rooftop, the building generally redirects wind over the roof and this can double the wind speed at the turbine. If the height of the rooftop mounted turbine tower is approximately 50% of the building height, this is near the optimum for maximum wind energy and minimum wind turbulence.

Finally, it is many times necessary to provide a wind machine with mechanism that allow it to be oriented into the wind. Certainly, this can be as simple as a vane and a rotatable mounting system, but even such a simple system adds to the cost, and may require periodic maintenance, repair and replacement.

U.S. Pat. No. 4,031,173, issued Jun. 21, 1977 to Rogers, relates to cooling towers of the type currently in use for cooling water and/or condensing exhaust steam as for example in association with nuclear or fossil fuel type power plants. Typically towers are very large and very high. The invention embodies an original concept for utilization of such towers, for example hyperbolic towers, for the generation of energy from wind and also for improving the efficiency of the cooling tower. In the exemplary form of the invention a large wind driven rotor is provided to be carried by the tower and to rotate around its axis at the position of the narrowed throat of the tower. Pressure is generated by the rotor and discharged through nozzles arrayed on the inside of the walls of the tower to augment and enhance the draft within the tower.

U.S. Pat. No. 6,327,994, issued Dec. 11, 2001, to Labrador, discloses a scavenger energy converter system, new applications therefore and control systems therefore. What has been invented is a series of scientific applications of the wideface energy converter device, be it in the form of a wideface solar heat receiver or a wideface fluid impeder device. The wider is the solar heat receiver, the more solar power is available for conversion. The wider is the sail of the boat, the more wind is available to push the boat. Wherefore, the wideface solar trap made up of multi-layer transparent roofs covering a heat insulated box is used to heat up a radiator tubings that contain water. The multilayer transparent roof, having spaces in between sheets, prevents solar heat from backing out hence the trap becomes hotter and hotter because the inner sheet is not in contact with the cold wind. This solar trap is now used to heat up radiator pipes of compressed air coming from a gas turbine engine and then returned back to the exhaust turbine of same engine. Applying the principle of the wind sail, the turbine blades of the compressor and the turbine blades of the exhaust turbine are made wideface as much as possible to produce maximum impedance against the expanding exhaust hot air and to produce maximum push upon the fresh air being compressed. This wideface fluid impeder is now expanded into an underwater platform from one acre or much more and attached to floating hotels, large/small boats, and floating sea walls, to prevent oscillation by the surfs.

United States Patent Application 20030111843, published Jun. 19, 2003 by Tallal et al., discloses a system and building for generating electricity using wind power. The invention includes an enclosure, a wind turbine and two or more air ducts. The enclosure, which is to be mounted within or in close proximity to a building, has an air intake and an air exhaust has an air intake and an air exhaust. The wind turbine generates electricity from the wind received from the air intake and is disposed within the enclosure between the air intake and the air exhaust. Each air duct has a first end connected to an air duct intake device and a second end connected to the enclosure air intake.

United States Patent Application 20050019150, published Jan. 27, 2005, by Yu, A windmill having a wind intake section that has wind guide plates, a wind inlet defined between two adjoining wind guide plates, and a wind inlet opening and closing device placed at the wind inlet. The wind inlet opening and closing device is opened by the wind flowing through the wind inlet into the windmill and closed by the wind flowing through the wind inlet out of the windmill. A power generating section is disposed to rotate rotors, by the wind introduced into the windmill through the wind intake section and thereby generate electricity. A wind exhaust section has a wind outlet, and a wind outlet opening and closing device placed at the wind outlet. The wind outlet opening and closing device is opened by the wind flowing through the wind outlet out of the windmill and closed by the wind flowing through the wind outlet into the windmill.

United States Patent Application 20050122679, published Jun. 9, 2005, by Von Gutfeld et al., discloses a method and apparatus for generating electricity using recycled air from a computer server. In one embodiment, the invention is a method and apparatus for recycling exhaust air expelled from a computer server (e.g., a unit including microprocessors such as a standard server or a mainframe). In one embodiment, at least one windmill (e.g., a standard windmill or a wind turbine) is driven by the exhaust air from at least one server unit, and the at least one windmill in turn drives a generator. Therefore, energy previously wasted in the form of exhaust is harnessed and reused to provide power to the server system. The method and apparatus also reduce the demand placed on ventilation systems needed to cool server environments, further reducing the amount of energy consumed and/or wasted in the operation of a server system. In one embodiment, the electric power from the generator unit is either recycled into the power grid. In another embodiment, the recycled air is used to charge batteries that might be available as power standby units.

United States Patent Application 20060257258, published Nov. 16, 2006, by Zwebner, discloses a co-generation power system for supplying electricity to an air-water recovery system. A mobile, self-propelled platform, includes an enclosed trailer containing a portable air-water recovery system. This trailer includes a wind turbine mounted outside of the closed trailer environment, and adapted for recovery of energy from an exhaust air stream that is vented from within the enclosed trailer environment. The energy generated from such exhaust air stream is used to supplement traditional power sources associated with the operation of water generation process. The energy recovered from the exhaust air stream is projected to reduce the overall operating cost of the air-water recovery system by least 25%, based upon its current energy consumption needs. This system has application to other environments in which a force air stream is produce incident to operation of a primary process, as for example, where a high pressure, air dryer is used to remove moisture from a product, or to accelerate a curing operation.

United States Patent Application 20070013192, published Jan. 18, 2007, and United States Patent Application 20070278795, published Dec. 6, 2007, both published by Berkson, both disclose a method for creating energy sources for a vehicle drive system that includes burning an air fuel mixture in an internal combustion engine and discharging the burned air fuel mixture through an exhaust system of the vehicle. Steam is created utilizing heat of the exhaust system. The steam is passed through a generator, which supplies mechanical or electrical power to an appropriate drive system of the vehicle. Hydrogen can be created utilizing the steam and a catalyst substrate. Wind turbines mounted to the vehicle can also supply electricity to the vehicle as air passes through the turbines due to movement of the vehicle.

United States Patent Application 20070012036, published Jan. 18, 2007 by Perry, discloses a rotating accessory for motor vehicle tail pipe. The motor vehicle has an internal combustion motor and a wheel drive mechanism, wherein the motor has an exhaust system connected thereto, and includes a) an exhaust system having an exhaust pipe and a rotating accessory, with the exhaust pipe being in a fixed position relative to the internal combustion motor, and the accessory being rotatably connected to the exhaust pipe, and b) an accessory drive mechanism connected to the accessory for rotation of the accessory. The accessory drive mechanism may operate off some power source of the vehicle, operate independently of the vehicle power sources, may operate from exiting exhaust gases, ambient wind form motion of the vehicle, or a combination of the foregoing.

United States Patent Application 20080272603, published Nov. 6, 2008 by Baca, discloses a wind-driven electrical power generation system that includes a cowling to capture wind and directs it into a tubular housing. At least one fixed helical vane can be integrated into the inner surfaces of the tubular housing in a spiral, adapted to further direct the captured wind into a spiraled air flow and focus the wind directly onto electrical generator fan blades located near an exhaust of the system. A generator cone can be mounted at the front of the generator or fan blades facing air passing through the tubular housing. As air passes over the generator cone it can experience compression between the generator cone and housing resulting in increased pressure and velocity of the air, thereby increasing rotational speed of the generator blades and generator as the compressed air passes through the blades and exits the system's exhaust. The system can be used for fixed or mobile applications.

United States Patent Application 20090072543, published Mar. 19, 2009, by Chia-Lung, discloses a wind power system that includes a frame, at least a power module installed in the frame and a motor, wherein the number of the at least a power module is increasable, and the respective power module is extractable from the frame through an extraction direction. The respective power module has a fan, a plurality of first wedging surfaces and a plurality of second wedging surfaces, wherein the first and second wedging surfaces respectively manage to cooperate with a second wedging surface of a first additional power module and a first wedging area of a second additional power module, and the motor is connected to the respective power module, thereby the fan of the respective power module being driven by a wind to cause the motor to generate the electricity.

All of the patents cited in this specification, are herein incorporated by reference.

However, in spite of the above advancements, there exists a need in the art for wind machines.

There also exists a need in the art for wind machines that make improvements on the intermittency problem.

There even also exists a need in the art for wind machines that make improvements on the capacity problem.

There still also exists a need in the art for wind machines that do not need to be specially mounted or positioned on towers or buildings just to capture wind.

There yet also exists a need in the art for wind machines that are not dependent upon be positioned geographically remote in order to obtain a source of wind.

These and other needs in the art will become apparent to those of skill in the art upon review of this specification, including its drawings and claims.

### SUMMARY OF THE INVENTION.

It is an object of the present invention to provide for methods and apparatus for generating electricity.

It is another object of the present invention to provide for methods and wind machines that make improvements on the intermittency problem.

It is even another object of the present invention to provide for methods and wind machines that make improvements on the capacity problem.

It is still another object of the present invention to provide for methods and wind machines that do not need to be specially mounted or positioned on towers or buildings just to capture wind.

It is yet another object of the present invention to provide for methods and wind machines that are not dependent upon be positioned geographically remote in order to obtain a source of wind.

This and other objects of the present invention will become apparent to those of skill in the art upon review of this specification, including its drawings and claims.

According to one embodiment of the present invention, there is provided a method of producing electricity. The method may include receiving at least a portion of first flowing exhaust gas stream from a gas turbine or reciprocating engine. The method may also include directing at least a portion of the first flowing exhaust gas stream into contact with a first engagement surface to move the first engagement surface and translate power to a first wind machine and generate electricity.

In a further sub-embodiment, this embodiment may further include wherein the first flowing exhaust gas stream leaves contact with the first engagement surface as a first residual flowing gas stream, with the method may further comprise directing at least a portion of the first residual flowing gas stream into contact with a second engagement surface to move the second engagement surface and translate power to a second wind machine and generate electricity.

In a further sub-embodiment, this embodiment may further include wherein the first residual flowing gas stream leaves contact with the second engagement surface as a second residual flowing gas stream, the method may further comprise, directing at least a portion of the second residual flowing gas stream into contact with a third engagement surface to move the third engagement surface and translate power to a third wind machine and generate electricity.

In a further sub-embodiment, this embodiment may further include wherein the second residual flowing gas stream leaves contact with the third engagement surface as a third residual flowing gas stream, the method may further comprise directing at least a portion of the third residual flowing gas stream into contact with a fourth engagement surface to move the fourth engagement surface and translate power to a fourth wind machine and generate electricity.

According to another embodiment of the present invention, there is provided a method of producing electricity. The method may include splitting at least a portion of a first flowing exhaust gas stream from a gas turbine or reciprocating engine into a first split flowing exhaust gas stream and a second split flowing exhaust gas stream. The method may also include directing at least a portion of the first split flowing exhaust gas stream into contact with a first engagement surface to move the first engagement surface and translate power to a first wind machine and generate electricity. The method may even also include directing at least a portion of the second split flowing exhaust gas stream into contact with a second engagement surface to move the second engagement surface and translate power to a second wind machine and generate electricity.

In a further sub-embodiment, this embodiment may further include wherein, the first split flowing exhaust gas stream leaves contact with the first engagement surface as a first residual flowing gas stream, and wherein the second split flowing exhaust gas stream leaves contact with the second engagement surface as a second residual flowing gas stream; the method may further comprise combining at least a portion of the first residual flowing gas stream and at least a portion of the second residual flowing gas stream into a combined stream, and the method even may further comprise directing at least a portion of the combined stream into contact with a third engagement surface to move the third engagement surface and translate power to a third wind machine and generate electricity.

In a further sub-embodiment, this embodiment may further include wherein the first split flowing exhaust gas stream leaves contact with the first engagement surface as a first residual flowing gas stream, and wherein the second split flowing exhaust gas stream leaves contact with the second engagement surface as a second residual flowing gas stream; the method may further comprise directing at least a portion of the first residual flowing gas stream and at least a portion of the second residual flowing gas stream into contact with a third engagement surface to move the third engagement surface and translate power to a third wind machine and generate electricity.

In a further sub-embodiment, this embodiment may further include wherein the first split flowing exhaust gas stream leaves contact with the first engagement surface as a first residual flowing gas stream, and wherein the second split flowing exhaust gas stream leaves contact with the second engagement surface as a second residual flowing gas stream; the method may further comprise directing at least a portion of the first residual flowing gas stream into contact with a third engagement surface to move the third engagement surface and translate power to a third wind machine and generate electricity. The method may even further comprise directing at least a portion of the second residual flowing gas stream into contact with a fourth engagement surface to move the fourth engagement surface and translate power to a fourth wind machine and generate electricity.

According to even another embodiment of the present invention, there is provided a method of producing electricity. This method may include splitting a flowing exhaust gas stream from a gas turbine or reciprocating engine into n number of split flowing exhaust gas streams, wherein n is an integer of at least 3. The method may even further include directing at least a portion of the i^{th} split flowing exhaust gas stream into contact with an i^{th} engagement surface to move the i^{th} engagement surface and translate power to an i^{th} wind machine and generate electricity, wherein i are integers from 1 to n.

According to still another embodiment of the present invention, there is provided an apparatus for producing electricity. The apparatus may include an electricity generating member having an exhaust system and a wind machine having an engagement surface positioned to receive a flowing gas stream from the exhaust system.

According to yet another embodiment of the present invention, there is provided an apparatus for producing electricity. The apparatus may include a first wind machine having an first engagement surface adapted to receive at least a portion of a flowing gas stream from an exhaust system of an electricity producing device; and, a second wind machine having a second engagement surface positioned to receive at least a portion of a first reduced gas stream from the first engagement surface.

In a further sub-embodiment, this embodiment may further include a third wind machine having a third engagement surface positioned to receive at least a portion of a second reduced gas stream from the second engagement surface; and/or a fourth wind machine having a fourth engagement surface positioned to receive at least a portion of third reduced gas stream from the third engagement surface.

According to even still another embodiment of the present invention, there is provided an apparatus for producing electricity. The apparatus may include a first wind machine having an first engagement surface positioned to receive a first portion of a flowing gas stream from an exhaust system of an electricity producing device; and/or a second wind machine having a second engagement surface positioned to receive a second portion of the flowing gas stream.

In a further sub-embodiment, this embodiment may further include a third wind machine having a third engagement surface positioned to receive at least a portion of a first reduced gas stream from the first engagement surface, and at least a portion of a second reduced gas stream from the second engagement surface.

In a further sub-embodiment, this embodiment may further include a third wind machine having a third engagement surface positioned to receive at least a portion of a first reduced gas stream from the first engagement surface; and/or a fourth wind machine having a fourth engagement surface positioned to receive at least a portion of a second reduced gas stream from the second engagement surface.

This and other embodiments of the present invention will become apparent to those of skill in the art upon review of this specification, including its drawings and claims.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is a schematic representation of one non-limiting embodiment of the apparatus of the present invention for generating electricity and shows exhaust generating member 101 and wind machine 201.

FIG. 2 a schematic representation of another non-limiting embodiment of the apparatus of the present invention for generating electricity and shows electricity generating member 101 providing exhaust 103 to more than one wind machine.

FIG. 3 is a schematic representation of even another non-limiting embodiment of the apparatus of the present invention for generating electricity and shows electricity generating member 101 providing exhaust 103 in a parallel fashion to a first set of wind machines 201, with the reduced flow from wind machines 201 provided to a second set of wind machines 301, with the reduced flow from wind machines 301 provided to a third set of wind machines 401.

FIG. 4 is a schematic representation of still another non-limiting embodiment of the apparatus of the present invention for generating electricity and shows electricity generating member 101 providing exhaust 103 in series through wind machines 201, 301, and 401.

FIG. 5 is a schematic representation of yet another non-limiting embodiment of the apparatus of the present invention for generating electricity, showing electricity generating member 101 providing exhaust 103 through wind machines 201, 301, and 401, and illustrating both a splitting and combining of streams in a single embodiment.

FIG. 6 is a schematic representation of even still another non-limiting embodiment of the apparatus of the present invention for generating electricity, showing two electricity generating members 101 providing exhaust 103 through wind machines 201, with an optional header 125 distributing exhaust stream 103 to the various wind machines 201, and an optional additional electricity generating member 102.

### DETAILED DESCRIPTION OF THE INVENTION

In some apparatus and method embodiments of the present invention, exhaust gases from a gas turbine or reciprocating engine may be utilized to power a wind machine and thus produce electricity. The exhaust gases may be used to directly or indirectly drive the wind machine, that is, the exhaust gases may be provided directly to a wind engagement surface of a wind machine, non-limiting examples of which include, blades, wings, fins, louvers, or shutters, with this surface translating power to an electrical generator. Alternatively, the exhaust gases may be provided in such a manner as to indirectly power the wind machine. As a non-limiting example, the exhaust gases may be utilized to power a wind producing device which in turn provides wind to the wind machines.

The present invention may include any suitable mechanical apparatus as desired to receive the exhaust gases, split the exhaust gases, combine the exhaust gases, control the exhaust gases, and/or translate power of the exhaust gases. The present invention may include gears, gearboxes, and the like as necessary.

Advantageously with the present invention, the exhaust is continuous with the running of the turbine or engine, overcoming capacity and/or intermittency issues of natural wind powered wind machines. Also advantageously, such a wind machine may be placed anywhere there is a turbine or engine, rather than having to find wind friendly locations.

One apparatus embodiment of the present invention for generating electricity may include a gas turbine or internal combustion engine, and a wind machine. In some embodiments, the apparatus may further include suitable structure for directing the exhaust from the gas turbine or reciprocating engine to the wind machine in such a manner as to operate the wind machine and generate electricity with the wind machine. In other embodiments, the gas turbine or internal combustion engine are integrated with the wind machine as a single unit in such a manner that the exhaust is provided to the wind machine within the confines of the single unit.

Non-limiting embodiments of the present invention may include logic in the form of software and/or hardware, and/or attendant hardware, for monitoring operating conditions and parameters relating to the wind machine, exhaust, gas turbine or reciprocating engine, load, output, and any other operating condition or parameter as desired, and consequently controlling apparatus as desired. For example, for increasing/decreasing load, more or less of the exhaust stream may be provided to the wind machine. Such logic is even more desired for the more complex embodiments involving multiple exhaust streams, splitting of streams, combining of streams, multiple wind machines, and/or the use of streams flowing through several wind machines in series or parallel.

Gas turbines and internal combustion engines are well known, and any suitable ones may be utilized in the practice of the present invention.

Likewise, wind machines are well known, and any suitable type of wind machine may be utilized in the present invention. As non-limiting examples, suitable wind machines may include horizontal-axis type wind machines and vertical-axis type wind machines.

As a non-limiting example, horizontal-axis wind turbines (HAWT) may have the main rotor shaft and electrical generator at the top of a tower, and may be pointed into the wind. Small turbines may be oriented into the wind by a simple wind vane, while large turbines may generally use a wind sensor coupled with a servomotor. These horizontal axis wind machines may have a gearbox, which turns the slow rotation of the blades (generally an engagement surface) into a quicker rotation that may be more suitable to drive an electrical generator. Turbine blades may be made stiff to prevent the blades from being pushed into the tower by high winds.

As another non-limiting example, vertical-axis wind turbines (or VAWTs) may have the main rotor shaft arranged vertically. Some advantages of this arrangement may include that the turbine does not need to be pointed into the wind to be effective. This may be an advantage on sites where the wind direction is highly variable. VAWTs may utilize winds from varying directions.

With a vertical axis, the generator and gearbox may be placed near the ground, so the tower does not need to support it, and it is more accessible for maintenance. Drawbacks may include that some designs produce pulsating torque. Additionally, drag may be created when the blade rotates into the wind.

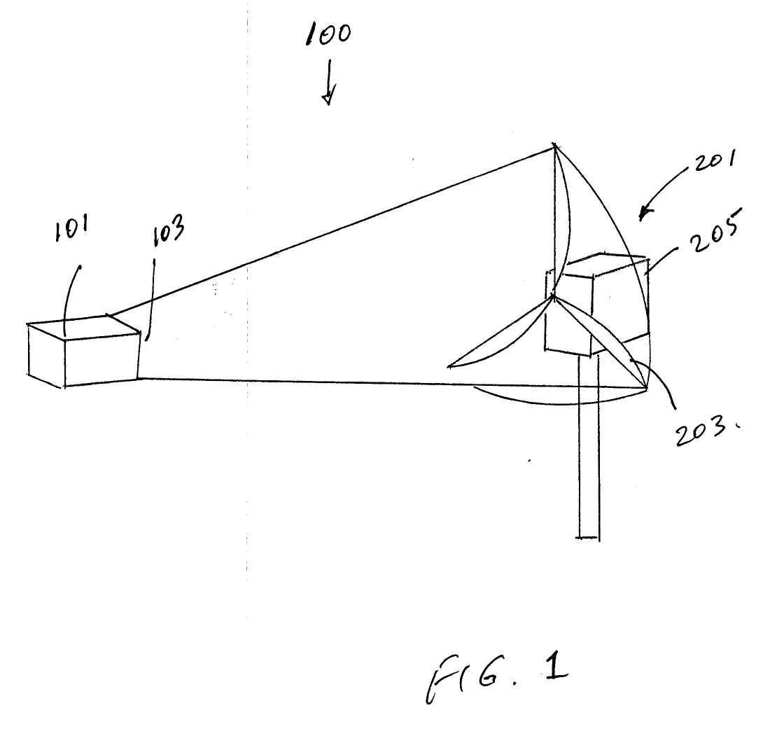

Referring now to FIG. 1, there is shown a schematic representation of one non-limiting embodiment of the apparatus of the present invention for generating electricity. FIG. 1 shows an electricity generating member 101 and wind machine 201. Various embodiments will include wind machine 201 and may optionally include electricity generating member 101. This exhaust generating member 101 generates an exhaust gas 103. Non-limiting examples of member 101 include a gas turbine or reciprocating engine. This exhaust gas 103 is then directed into contact with engaging surface 203. Once this exhaust gas 103 contacts engaging surface 203, it will leave engaging surface 203 as reduced gas, generally having less velocity because of work imparted to engaging surface 203. In some non-limiting embodiments of the present invention, this reduced gas stream may be utilized to power one or more subsequent wind machines. Movement of engaging surface 203 will generally rotate a rotor within generator 205 to generate electricity from wind machine 201. In the non-limiting example as shown in FIG. 1, engaging surface 203 is a rotor or blade. While three blades 203 are shown in FIG. 1, it should be noted that for this and any other embodiment any suitable number of engaging surfaces may be utilized, including 1, 2, 3, 4, 5, 6, 7, 8, 9, 10, or more engaging surfaces. It should be further noted that for this and any other embodiment engaging surface 203 may be any suitable shape.

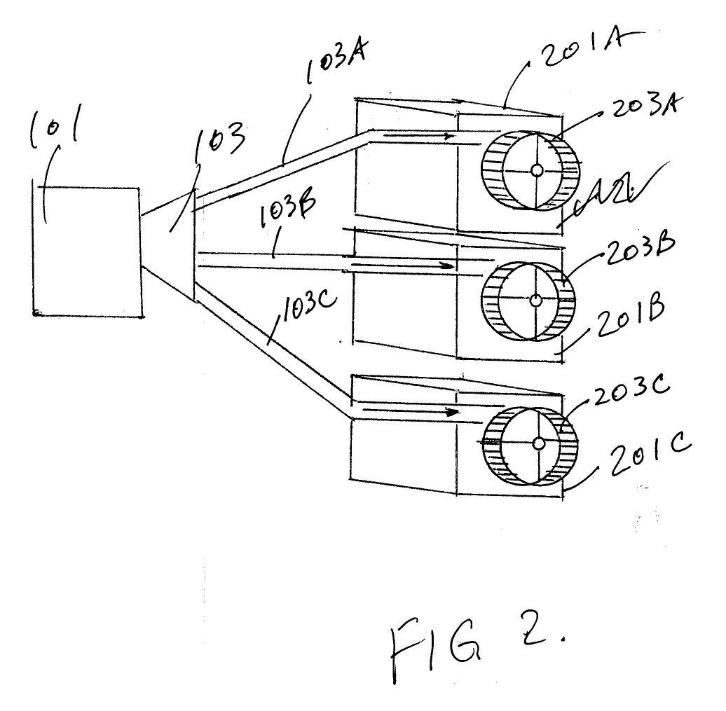

Referring now to FIG. 2 there is shown a schematic representation of another non-limiting embodiment of the apparatus of the present invention for generating electricity. FIG. 2 shows electricity generating member 101 providing exhaust 103 in a parallel fashion to more than one wind machine. Again, non-limiting examples of member 101 include a gas turbine or reciprocating engine. As shown, this exhaust gas 103 is split into streams 103A, 103B and 103C, with each of these being provided to a respective wind machine 201A, 201B, and 201C, for the generation of electricity. Once these exhaust gas steams 103A, 103B and 103C contact their respective engaging surfaces 203A, 203B and 203C, they will leave as reduced gas streams, generally having less velocity because of work imparted to the engaging surfaces. In some non-limiting embodiments of the present invention, these reduced gas streams may be utilized to power one or more subsequent wind machines. These reduced gas streams may be combined, split or used as is, in one or more subsequent wind machines.

While three wind machines are shown in the embodiment of FIG. 2, it should be understood that exhaust 103 may be split and provided to any number two or more wind machines may be utilized, non-limiting examples of which include embodiments having 2, 3, 4, 5, 6, 7, 8, 9, 10, or more wind machines. Certainly, more than one exhaust 103 may be utilized. It should also be understood that the wind machines may be provided with the same or different volumetric flows of exhaust gas. Volumetric flow of gas to any particular wind machine may be increased or decreased depending upon the load on the particular wind machine, or any other operating conditions. The various wind machines may or may not have the same electricity generating capacity, and may be operated to produce the same or different outputs.

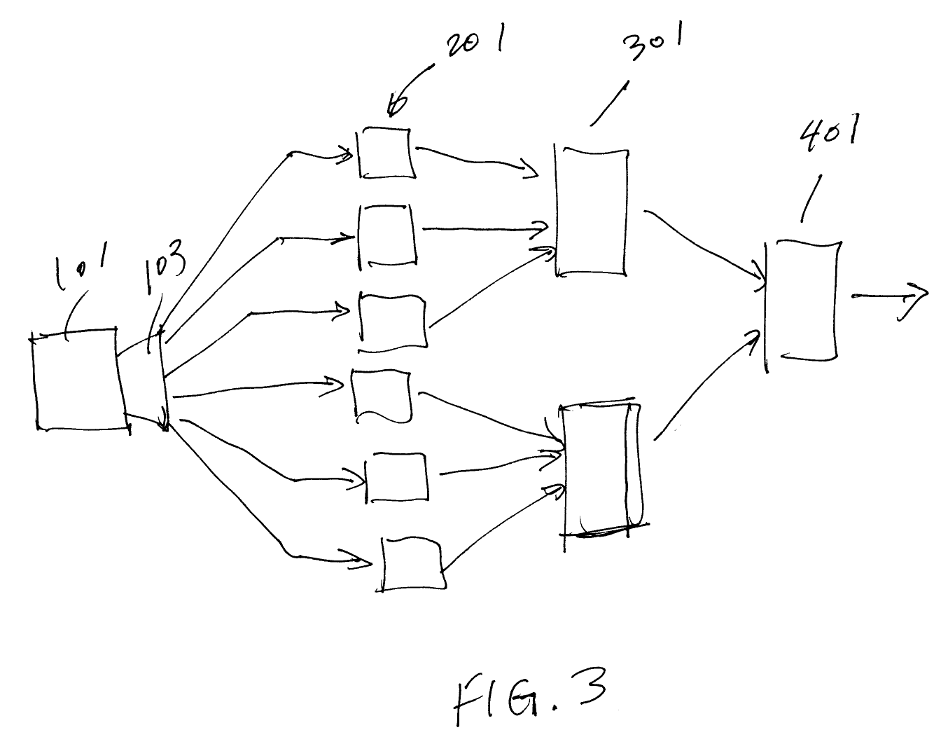

Referring now to FIG. 3 there is shown a schematic representation of even another non-limiting embodiment of the apparatus of the present invention for generating electricity. FIG. 3 shows electricity generating member 101 providing exhaust 103 in a parallel fashion to a first set of wind machines 201, with the reduced flow from wind machines 201 provided to a second set of wind machines 301, with the reduced flow from wind machines 301 provided to a third set of wind machines 401. Again, non-limiting examples of member 101 include a gas turbine or reciprocating engine.

As illustrated in FIG. 3, reduced flow from a first set of wind machines 201 may be combined and provided to a second set of wind machines 301, and reduced flow from the second set of wind machines 301 may be combined and provided to a third set of wind machines 401. It should be understood that the reduced flow streams from wind machines 201 and 301, may be combined before being provided to the next wind machines 301 or 401, or the reduced streams may just be provided to those subsequent wind machines as separate streams that are combined at the wind machine. In other words, the combining of the streams may take place prior to reaching the subsequent machine, or may arrive at the subsequent wind machine separately and be joined at the machine itself. While FIG. 3 shows that flow from 2 or 3 machines may be combined, the embodiment is not limited to combining 2 or 3 flow, but rather it should be understood that flow may be combined from 2, 3, 4, 5, 6, 7, 8, 9, 10, or more machines and provided to a subsequent wind machine. Certainly, reduced flow may be provided to further machines until the flow is no longer sufficient to provide power as desired. Furthermore, it is not necessary to combine flow, as a stream may be provided to a subsequent wind machine without combining it with another stream. Additionally, in some non-limiting embodiments, only a portion of a stream may be provided to a subsequent wind machine.

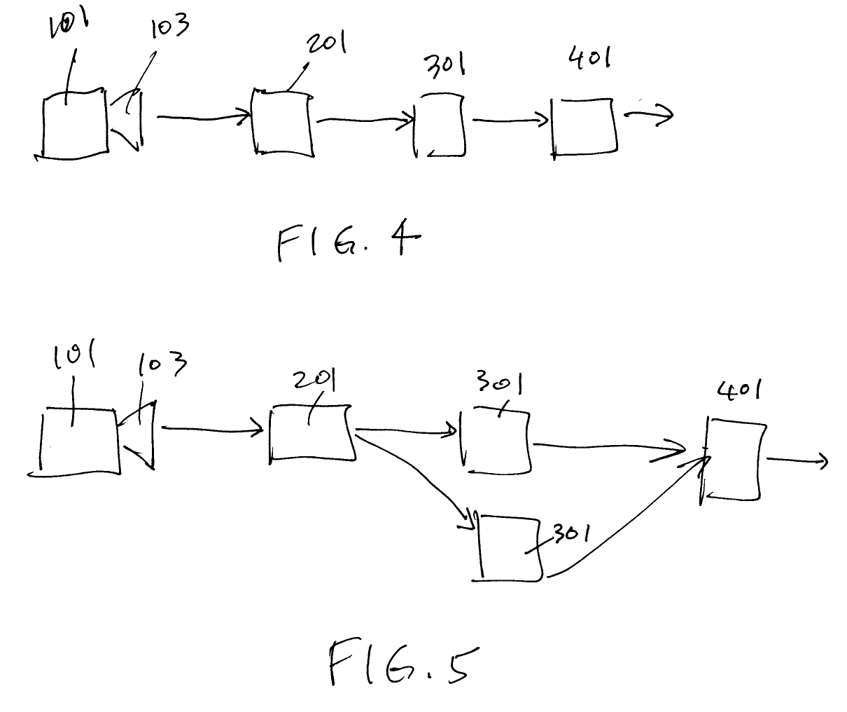

Referring now to FIG. 4, there is shown a schematic representation of still another non-limiting embodiment of the apparatus of the present invention for generating electricity. As shown in FIG. 4, electricity generating member 101 provides exhaust 103 in series through wind machines 201, 301, and 401. Certainly, any number of two or more wind machines may be operated in series. Generally, at some point the flow is reduced to such a point as to be unusable alone to power another wind machine.

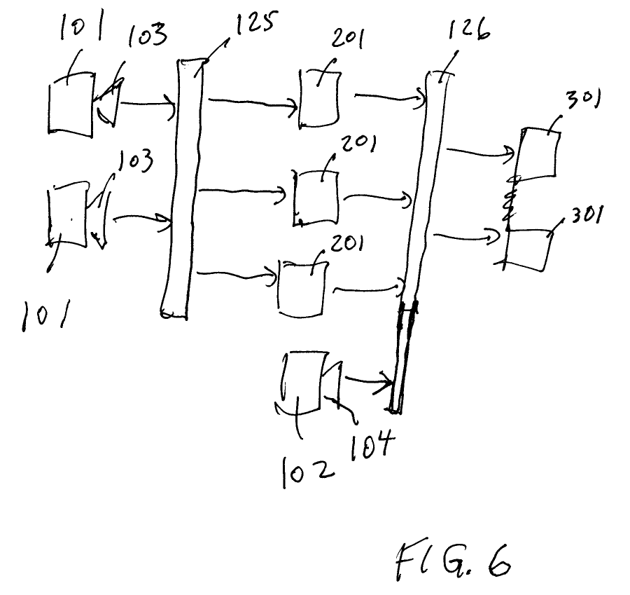

Referring now to FIG. 5, there is shown a schematic representation of yet another non-limiting embodiment of the apparatus of the present invention for generating electricity. As shown in FIG. 5, electricity generating member 101 provides exhaust 103 through wind machines 201, 301, and 401. The reduced flow from wind machine 201 is split and provided to the two wind machines 301. The reduced flow from wind machines 301 is provided, either combined or uncombined, to wind machine 401.

Referring now to FIG. 6, there is shown a schematic representation of even still another non-limiting embodiment of the apparatus of the present invention for generating electricity. As shown in FIG. 6, two electricity generating members 101 (and there may be 3, 4, 5, 6, 7, 8, 9, 10 or more) provides exhaust 103 through wind machines 201. An optional header 125 helps distribute exhaust stream 103 to the various wind machines 201. Exhaust 104 from an optional additional electricity generating member 102, and reduced flow from wind machines 201 is provided to header 126, from where it is split and provided to the two wind machines 301. Of course, any number of additional electricity generating members may be utilized throughout. Optionally, for both headers 125 and 126, various louvers, valves and the like, may be used to direct same or different flows to the subsequent wind machines.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

1. A method of producing electricity, comprising:
Receiving at least a portion of first flowing exhaust gas stream from a gas turbine or reciprocating engine; and,
Directing at least a portion of the first flowing exhaust gas stream into contact with a first engagement surface to move the first engagement surface and translate power to a first wind machine and generate electricity.

2. The method of claim 1, wherein the first flowing exhaust gas stream leaves contact with the first engagement surface as a first residual flowing gas stream, the method further comprising:
Directing at least a portion of the first residual flowing gas stream into contact with a second engagement surface to move the second engagement surface and translate power to a second wind machine and generate electricity.

3. The method of claim 2, wherein the first residual flowing gas stream leaves contact with the second engagement surface as a second residual flowing gas stream, the method further comprising:
Directing at least a portion of the second residual flowing gas stream into contact with a third engagement surface to move the third engagement surface and translate power to a third wind machine and generate electricity.

4. The method of claim 3, wherein the second residual flowing gas stream leaves contact with the third engagement surface as a third residual flowing gas stream, the method further comprising:
Directing at least a portion of the third residual flowing gas stream into contact with a fourth engagement surface to move the fourth engagement surface and translate power to a fourth wind machine and generate electricity.

5. A method of producing electricity, comprising:
Splitting at least a portion of a first flowing exhaust gas stream from a gas turbine or reciprocating engine into a first split flowing exhaust gas stream and a second split flowing exhaust gas stream;
Directing at least a portion of the first split flowing exhaust gas stream into contact with a first engagement surface to move the first engagement surface and translate power to a first wind machine and generate electricity; and
Directing at least a portion of the second split flowing exhaust gas stream into contact with a second engagement surface to move the second engagement surface and translate power to a second wind machine and generate electricity.

6. The method of claim 5, wherein the first split flowing exhaust gas stream leaves contact with the first engagement surface as a first residual flowing gas stream, and wherein the second split flowing exhaust gas stream leaves contact with the second engagement surface as a second residual flowing gas stream; the method further comprising:
combining at least a portion of the first residual flowing gas stream and at least a portion of the second residual flowing gas stream into a combined stream;
directing at least a portion of the combined stream into contact with a third engagement surface to move the third engagement surface and translate power to a third wind machine and generate electricity.

7. The method of claim 5, wherein the first split flowing exhaust gas stream leaves contact with the first engagement surface as a first residual flowing gas stream, and wherein the second split flowing exhaust gas stream leaves contact with the second engagement surface as a second residual flowing gas stream; the method further comprising:
directing at least a portion of the first residual flowing gas stream and at least a portion of the second residual flowing gas stream into contact with a third engagement surface to move the third engagement surface and translate power to a third wind machine and generate electricity.

8. The method of claim 5, wherein the first split flowing exhaust gas stream leaves contact with the first engagement surface as a first residual flowing gas stream, and wherein the second split flowing exhaust gas stream leaves contact with the second engagement surface as a second residual flowing gas stream; the method further comprising:
directing at least a portion of the first residual flowing gas stream into contact with a third engagement surface to move the third engagement surface and translate power to a third wind machine and generate electricity; and,
directing at least a portion of the second residual flowing gas stream into contact with a fourth engagement surface to move the fourth engagement surface and translate power to a fourth wind machine and generate electricity.

9. A method of producing electricity, comprising:
Splitting a flowing exhaust gas stream from a gas turbine or reciprocating engine into n number of split flowing exhaust gas streams, wherein n is an integer of at least 3; and,
Directing at least a portion of the i^{th} split flowing exhaust gas stream into contact with an i^{th} engagement surface to move the i^{th} engagement surface and translate power to an i^{th} wind machine and generate electricity, wherein i are integers from 1 to n.

10. An apparatus for producing electricity, comprising:
An electricity generating member having an exhaust system;
A wind machine having an engagement surface positioned to receive a flowing gas stream from the exhaust system.

11. An apparatus for producing electricity, comprising:
a first wind machine having an first engagement surface adapted to receive at least a portion of a flowing gas stream from an exhaust system of an electricity producing device; and,
a second wind machine having a second engagement surface positioned to receive at least a portion of a first reduced gas stream from the first engagement surface.

12. The apparatus of claim 11, further comprising:
a third wind machine having a third engagement surface positioned to receive at least a portion of a second reduced gas stream from the second engagement surface.

13. The apparatus of claim 12, further comprising:
a fourth wind machine having a fourth engagement surface positioned to receive at least a portion of third reduced gas stream from the third engagement surface.

14. An apparatus for producing electricity, comprising:
a first wind machine having an first engagement surface positioned to receive a first portion of a flowing gas stream from an exhaust system of an electricity producing device; and,
a second wind machine having a second engagement surface positioned to receive a second portion of the flowing gas stream.

15. The apparatus of claim 14, further comprising:
a third wind machine having a third engagement surface positioned to receive at least a portion of a first reduced gas stream from the first engagement surface, and at least a portion of a second reduced gas stream from the second engagement surface.

16. The apparatus of claim 14, further comprising:
a third wind machine having a third engagement surface positioned to receive at least a portion of a first reduced gas stream from the first engagement surface; and
a fourth wind machine having a fourth engagement surface positioned to receive at least a portion of a second reduced gas stream from the second engagement surface.
